(19) United States
(12) Patent Application Publication
(10) Pub. No.: US 2011/0209823 A1
(43) Pub. Date: Sep. 1, 2011

(54) METHOD FOR MANUFACTURING OF CERAMIC BRAKE DISK ROTOR WITH INTERNAL COOLING CHANNEL

(75) Inventors: Dong Won Im, Gyeongsangnam-do (KR); Yeon Ho Choi, Gyeongsangnam-do (KR); Jun Sang Lee, Seoul (KR); Jeong Seok Kang, Jeonbuk (KR); Hyun Kyu Shin, Gyeongsangnam-do (KR)

(73) Assignee: DACC CO., LTD., Gyeongsangnam-do (KR)

(21) Appl. No.: 13/121,802

(22) PCT Filed: Dec. 17, 2008
(86) PCT No.: PCT/KR2008/007456

§ 371 Date: May 24, 2011

(30) Foreign Application Priority Data
Sep. 30, 2008 (KR) 10-2008-0095934

(51) Int. Cl. B32B 37/02; B32B 37/12; B32B 37/16; B32B 38/00; B32B 38/04

(52) U.S. Cl. 156/276; 156/297; 156/293

(57) ABSTRACT

The present invention relates to a method of more precisely and easily realizing cooling channels constituting a ceramic brake disk rotor. In order to achieve an object of the invention, there is provided a method of manufacturing a ceramic brake disk rotor having internal cooling channels, comprising the steps of: (a) producing loading portions 110, 210, frictional surfaces 120, 220, and vanes 300 of the disk rotor respectively through separate processes using a carbon fiber reinforced carbon-carbon composite; (b) fabricating the loading portions 110, 210, frictional surfaces 120, 220, and vanes 300 respectively produced through separate processes into one structure and (c) performing a liquid silicon-melt infiltration process for the fabricated one structure. According to the present invention, a shape of the cooling channel can be economically and easily realized, and furthermore the dimensional precision of the cooling channel is enhanced, thereby having an effect of improving the performance of the disk rotor.

### TECHNICAL FIELD

The present invention relates to a method of manufacturing a ceramic brake disk rotor having internal cooling channels, and more particularly, to a method of more precisely and easily realizing cooling channels constituting a ceramic brake disk rotor.

### BACKGROUND ART

In general, brake systems are mostly foot brakes in a manner that are actuated by foot control through a driver, as a device for slowing down or stopping a car while driving, and the actuating force of the driver, i.e., pedal force is converted to the braking force of a wheel through the medium of hydraulic or pneumatic pressure. Of such hydraulic brakes, disk brake is mounted with a cylindrical disk rotor that is rotating along with the wheel instead of a drum to push brake pads operated by a hydraulic piston against both outer surfaces of the disk rotor, thereby braking wheels by the frictional force.

The structure of the disk brake includes a disk rotor, a caliper, disk pads, and the like.

FIG. 1 is a perspective view illustrating a structure of a conventional disk rotor. As illustrated in FIG. 1, a convention disk rotor 1 performs a process of converting kinetic energy to thermal energy at the time of braking, and therefore is formed with cooling channels 10 for cooling thermal energy up to several hundred degrees at the time of braking. Furthermore, the cooling channels 10 have a shape in which the channels penetrating from the outer circumference of the disk rotor 1 to the inner circumference are formed at regular intervals along to the direction of the circumference.

FIG. 2 is a view for explaining a method of manufacturing a conventional disk rotor. With reference to FIG. 2, for example, in the prior art when manufacturing a disk rotor using a carbon-carbon composite, the disk rotor is manufactured by any one of the following three processes.

A first method of manufacturing a conventional disk rotor, in the step of forming a carbon-carbon composite of the disk rotor as illustrated in FIG. 2, a ceramic brake disk rotor as an integrated body is manufactured by respectively producing an upper plate 20 and a lower plate 30 in an upper/lower symmetrical manner (at this time, a half shape for forming a shape of cooling channels 10 is formed at each of the upper plate 20 and the lower plate 30) and then forming an assembly by a combining process (at this time, a shape of the cooling channels 10 is form by combining the upper plate 20 and the lower plate 30), and performing a liquid silicon-melt infiltration process. However, in order to form the cooling channels 10, the upper plate 20 and lower plate 30 produced in this way should be fabricated in a correct position for forming the cooling channels 10 in the upper plate 20 and lower plate 30, and especially highly strict processing tolerances are required at a surface having cooling channels 10 not to create a gap on the fabricated boundary surface. This processing characteristic functions as a main reason for increasing machine processing cost and time in the step of forming a carbon-carbon composite of the disk rotor.

A second method of manufacturing a conventional disk rotor, in the step of producing a carbon fiber-reinforced polymer (hereinafter, CFRP) of the disk rotor, it is used a manufacturing method in which a process for forming an upper plate and a lower plate in such an upper/lower symmetrical manner is omitted in the step of forming a carbon-carbon composite of the disk rotor by respectively producing the upper plate 20 and the lower plate 30 in an upper/lower symmetrical manner as illustrated in FIG. 2 (also at this time, a half shape for forming the cooling channels 10 is formed at each of the upper plate 20 and the lower plate 30).

However, a warp or dimensional change is also created during a thermal treatment process step by such a method, and additional processes are required, thereby having a problem similar to the first method.

A third method of manufacturing a conventional disk rotor, as a recent processing technology by which the second method is enhanced, is a method in which a material having an internal cooling channel shape is additionally inserted during a press molding process, and then incinerated during a thermal treatment process for producing a carbon-carbon composite of the disk rotor. Specifically, such a third method is a simultaneous molding method in which a raw material capable of press molding is produced, and a raw material applicable to the upper plate 20 is filled into the press mold, and a material having a shape of the cooling channels 10 is charged, and then a raw material applicable to the lower plate 30 is filled into the press mold. This method is evaluated as a relatively effective manufacturing method because an accurate shape and dimension can be satisfied even with a minimal machining processing after a thermal treatment process for producing a carbon-carbon composite of the disk rotor.

However, such a method also has a disadvantage that the selection of a material having a shape of the cooling channels 10 is very restrictive. Specifically, during a molding process of the disk rotor 1 by such a method, a low-density region is easily created in a vane 40 shaped portion, and therefore, to remove such a problem, a material having a shape of the cooling channels 10 should also be contracted as much as a contraction ratio of the raw material applicable to the upper plate 20 or the lower plate 30 during the molding process, and this contraction phenomenon should be made only in a thickness direction.

### DISCLOSURE OF INVENTION

### Technical Problem

The present invention is devised to solve such a conventional problem, and it is an object of the invention to produce an upper plate, a lower plate, and vanes of a disk rotor using separate processes respectively, and then fabricating these elements, thereby precisely and easily realizing cooling channels using a liquid silicon-melt infiltration process.

### Technical Solution

In order to achieve such an object of the invention, a method of manufacturing a ceramic brake disk rotor having internal cooling channels according to a first embodiment of the present invention, includes the steps of (a) producing loading portions 110, 210, frictional surfaces 120, 220, and vanes 300 of the disk rotor respectively through separate processes using a carbon fiber reinforced carbon-carbon composite;(b) fabricating the loading portions 110, 210, frictional surfaces 120, 220, and vanes 300 respectively produced through separate processes into one structure and (c) performing a liquid silicon-melt infiltration process on the fabricated one structure.

According to a preferred embodiment, the carbon-carbon composite in the step (a) may be formed by a process including the steps of (a1) producing a carbon fiber-reinforced polymer (CFRP) that is reinforced by carbon fiber; and (a2) producing a carbon-carbon composite by performing a high thermal treatment or densification on the carbon fiber-reinforced polymer.

According to a preferred embodiment, the loading portions 110, 210, the vanes 300, and the frictional surfaces 120, 220 may be formed by a carbon-carbon composite having a same composition ratio.

According to a preferred embodiment, the loading portions 110, 210 and the vanes 300 may be formed by a carbon-carbon composite having a same composition ratio, and the frictional surfaces 120, 220 may be formed by a carbon-carbon composite having a different composition ratio from the loading portions 110, 210 and the vanes 300.

According to a preferred embodiment, when the loading portions 110, 210, the vanes 300, and the frictional surfaces 120, 220 are formed with a carbon-carbon composite having a same composition ratio, carbon fiber having a length greater than 1 mm may be applied to the loading portions 110, 210, the vanes 300, and the frictional surfaces 120, 220 as a reinforced material, and the loading portions 110, 210, the vanes 300, and the frictional surfaces 120, 220 after performing the liquid silicon-melt infiltration process may be synthesized with a composition ratio containing 30-70 wt % of C-component, 2-15 wt % of Si-component, and 35-65 wt % of SiC-component.

According to a preferred embodiment, when the loading portions 110, 210 and the vanes 300 are formed with a carbon-carbon composite having a same composition ratio, and the frictional surfaces 120, 220 are formed with a carbon-carbon composite having a different composition ratio from the loading portions 110, 210 and the vanes 300, carbon fiber having a length greater than 1 mm may be applied to a carbon-carbon composite for the loading portions 110, 210 and the vanes 300 as a reinforced material, and carbon fiber having a length less than 1 mm may be applied to a carbon-carbon composite for the frictional surfaces 120, 220 as a reinforced material, and the frictional surfaces 120, 220 after performing the liquid silicon-melt infiltration process may be synthesized with a composition ratio containing 55-99 wt % of SiC-component and 1-45wt % of C-component, and the loading portions 110, 210 and the vanes 300 after performing the liquid silicon-melt infiltration process may be synthesized with a composition ratio containing 30-70 wt % of C-component, 2-15 wt % of Si-component, and 35-65 wt % of SiC-component.

According to a preferred embodiment, the shape of the vanes 300 may be produced by any one of a spiral shape, a linear shape, and a pin shape.

Furthermore, in order to achieve such an object of the invention, a method of manufacturing a ceramic brake disk rotor having internal cooling channels according to a second embodiment of the present invention, includes the steps of (a) producing an upper loading portion 110, a lower loading portion 210, and vanes 300 respectively through separate processes using a carbon fiber reinforced carbon-carbon composite; (b) fabricating the upper loading portion 110, the lower loading portion 210, and the vanes 300 respectively produced through separate processes into one structure and (c) performing a liquid silicon-melt infiltration process on the fabricated structure.

According to a preferred embodiment, the fabrication in the step (b) may be fabricated by applying a graphite adhesive between the lower loading portion 210 and the vanes 300, and between the vanes 300 and the upper loading portion 110.

According to a preferred embodiment, the fabrication in the step (b) may be fabricated by respectively forming grooving portions 500 in which the vanes 300 are inserted into the lower loading portion 210 and the upper loading portion 110 in advance, and inserting the vanes 300 into each of the grooving portions 500.

### Advantageous Effects

According to a method of manufacturing a ceramic brake disk rotor according to the present invention, it is possible to realize a shape of cooling channels more economically and easily.

Furthermore, according to a method of manufacturing a ceramic brake disk rotor according to the present invention, the dimensional precision of cooling channels is enhanced, thereby having an effect of improving the performance of a disk rotor.

### BRIEF DESCRIPTION OF THE DRAWINGS

FIG. 1 is a perspective view illustrating a structure of a conventional disk rotor.

FIG. 2 is a view for explaining a method of manufacturing a conventional disk rotor.

FIG. 3 is a flowchart for explaining a method of manufacturing a ceramic brake disk rotor having internal cooling channels according to a first embodiment of the present invention.

FIG. 4 is a view illustrating each element applied to a method of manufacturing a disk rotor of the present invention.

FIG. 5 is an exemplary view of vane shapes applicable to a method of manufacturing a disk rotor of the present invention.

FIGS. 6 and 7 are views for explaining each process of fabricating loading portions, vanes, and frictional surfaces applied to a method of manufacturing a disk rotor of the present invention.

FIG. 8 is a cross-sectional view illustrating a state in which grooved portions for inserting vanes between a lower loading portion and an upper loading portion are formed.

FIG. 9 is a flowchart for explaining a method of manufacturing a ceramic brake disk rotor having internal cooling channels according to a second embodiment of the present invention.

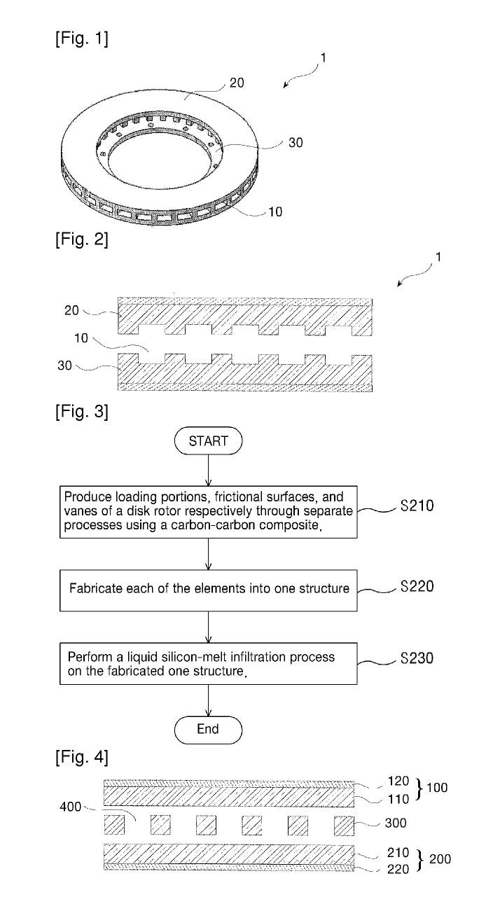

### BEST MODE FOR CARRYING OUT THE INVENTION

Hereinafter, preferred embodiments of the present invention will be described in detail with reference to the accompanying drawings.

### First Embodiment

FIG. 3 is a flowchart for explaining a method of manufacturing a ceramic brake disk rotor having internal cooling channels according to a first embodiment of the present invention, and FIG. 4 is a view illustrating each element applied to a method of manufacturing a disk rotor of the present invention.

Referring to FIGS. 3 and 4, a method of manufacturing a ceramic brake disk rotor having internal cooling channels according to the present invention, includes a step S210 of producing loading portions 110, 210, frictional surfaces 120, 220, and vanes 300 of the disk rotor respectively through separate processes using a carbon fiber reinforced carbon-carbon composite, a step S220 of fabricating the loading portions 110, 210, frictional surfaces 120, 220, and vanes 300 respectively produced through separate processes into one structure, and a step S230 of performing a liquid silicon-melt infiltration process on the fabricated one structure.

The step S210 of producing loading portions 110, 210, frictional surfaces 120, 220, and vanes 300 of the disk rotor respectively through separate processes using a carbon fiber reinforced carbon-carbon composite constituting the present invention is a process of preparing a carbon-carbon composite having an outstanding thermal resistance, high-temperature strength, and high-temperature dimensional stability, and then forming the loading portions 110, 210, frictional surfaces 120, 220, and vanes 300 into a predetermined shape that is applied to the disk rotor by machine process.

According to a preferred embodiment, the carbon-carbon composite in the step S210 may be formed by a process, including a step S210-1 of producing a carbon fiber-reinforced polymer (CFRP) that is reinforced by carbon fiber; and a step of S210-2 of producing a carbon-carbon composite by performing a high thermal treatment or densification on the carbon fiber-reinforced polymer.

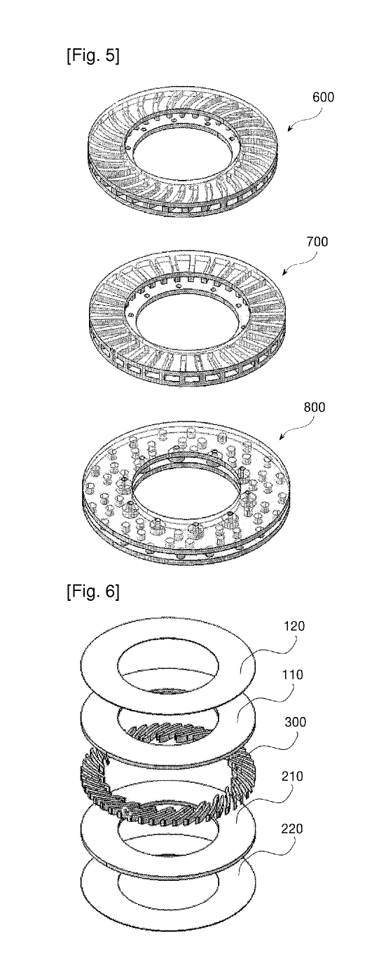

Furthermore, according to a preferred embodiment, a process of forming the loading portions 110, 210, frictional surfaces 120, 220, and vanes 300 into a predetermined shape that is applied to the disk rotor by machine process may be performed in the step S210-2 (the step of producing a carbon-carbon composite). In this embodiment, in the step of producing a carbon-carbon composite (step S210-2) an upper plate 100 (an upper loading portion 110 and an upper frictional surface 120) and a lower plate 200 (a lower loading portion 210 and a lower frictional surface 220) are machine processed into a planar circular disk shape, and a portion of the vanes 300 is also machine processed into a predetermined shape using a carbon-carbon composite similar to the upper plate 100 and lower plate 200. The upper plate 100 and lower plate 200 having a planar circular disk shape have a simple shape, and therefore can be processed in a relatively easy way even though strict processing tolerances are applied. Furthermore, the vanes 300 may be also produced into various shapes according to the characteristic of the required brake using cutting processing devices such as a water-jet. For example, as illustrated in FIG. 5, the vanes 300 according to this embodiment could be produced into various shapes, such as a spiral shape 600, a linear shape 700, and a cylindrical pin shape 800 according to the characteristic of the required brake.

The loading portions 110, 210, the vanes 300, and the frictional surfaces 120, 220 according to this embodiment may be formed by a carbon-carbon composite having a same composition ratio, but on the other hand, the loading portions 110, 210 and the vanes 300 may be formed by a carbon-carbon composite having a same composition ratio, and the frictional surfaces 120, 220 may be formed by a carbon-carbon composite having a different composition ratio from the loading portions 110, 210 and the vanes 300.

According to a preferred embodiment, when the loading portions 110, 210, the vanes 300, and the frictional surfaces 120, 220 are formed with a carbon-carbon composite having a same composition ratio, carbon fiber having a length greater than 1 mm may be applied to the loading portions 110, 210, the vanes 300, and the frictional surfaces 120, 220 as a reinforced material. In this case, it is processed such that the density of the carbon-carbon composite for the loading portions 110, 210, the vanes 300, and the frictional surfaces 120, 220 has a value of 1.0-1.7 g/cm³ (before the liquid silicon-melt infiltration process), and the loading portions 110, 210, the vanes 300, and the frictional surfaces 120, 220 after a step S230 of performing the liquid silicon-melt infiltration process on a fabricated disk rotor structure, which will be described later, are synthesized with a composition ratio containing 30-70 wt % of C-component, 2-15 wt % of Si-component, and 35-65 wt % of SiC-component.

According to a preferred embodiment, when the loading portions 110, 210 and the vanes 300 are formed with a carbon-carbon composite having a same composition ratio, and the frictional surfaces 120, 220 are formed with a carbon-carbon composite having a different composition ratio from the loading portions 110, 210 and the vanes 300, carbon fiber having a length greater than 1 mm may be applied to a carbon-carbon composite for the loading portions 110, 210 and the vanes 300 as a reinforced material, and carbon fiber having a length less than 1 mm may be applied to a carbon-carbon composite for the frictional surfaces 120, 220 as a reinforced material. In this case, it may be processed such that the density of the carbon-carbon composite for the loading portions 110, 210 and the vanes 300 before the liquid silicon-melt infiltration process has a value of 1.0-1.7 g/cm³, and the density of the carbon-carbon composite for the frictional surfaces 120, 220 before the liquid silicon-melt infiltration process has a value of 0.5-1.5 g/cm³ (before the liquid silicon-melt infiltration process), and the frictional surfaces 120, 220 after a step of S230 of performing the liquid silicon-melt infiltration process on a fabricated disk rotor structure, which will be described later, are synthesized with a composition ratio containing 55-99 wt % of SiC-component and 1-45 wt % of C-component, and the loading portions 110, 210 and the vanes 300 are synthesized with a composition ratio containing 30-70 wt % of C-component, 2-15 wt % of Si-component, and 35-65 wt % of SiC-component.

In other words, in case of a ceramic brake disk rotor, frictional surfaces having a different material characteristic from loading portions or vanes may be required, and at this time, it are processed such that carbon fiber having a length greater than 1 mm is applied to a reinforced material of the carbon-carbon composite, and the density of the carbon-carbon composite has a value of 0.5-1.5 g/cm³, and they are synthesized with a composition ratio containing 55-99 wt % of SiC-component and 1-45 wt % of C-component by a liquid silicon-melt infiltration process. Accordingly, the life of the ceramic brake disk rotor can be extended, and the frictional coefficient of the disk rotor at the time of braking is very high, above 0.35.

In the step S210 of producing loading portions 110, 210, frictional surfaces 120, 220, and vanes 300 of the disk rotor respectively through separate processes using a carbon fiber reinforced carbon-carbon composite constituting the present invention, a shape of the vanes 300 is separately produced, and therefore internal cooling channels 400 may be formed without any restriction on their shape. In other words, the shape of the vanes 300 for a ceramic brake disk rotor is mostly required to have a shape with various and complicated internal cooling channels to effectively radiate frictional heat created at the time of braking, and in this invention the internal cooling channels 400 of such a ceramic brake disk rotor may be produced into various shapes, such as a spiral shape 600, a linear shape 700, and a chaotic array 800.

The step S220 of fabricating the loading portions 110, 210, frictional surfaces 120, 220, and vanes 300 respectively produced through separate processes into one structure, constituting the present invention, is a process in which the loading portions 110, 210, frictional surfaces 120, 220, and vanes 300 are firmly fixed into one structure.

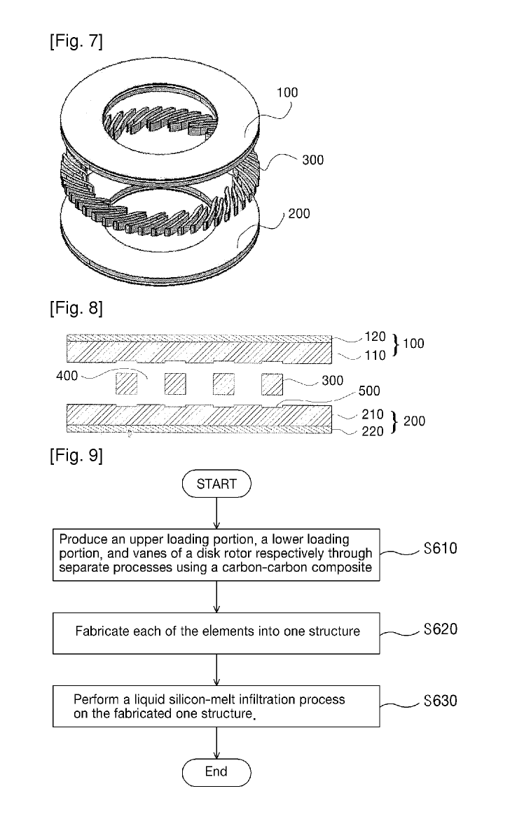

Furthermore, FIGS. 6 and 7 are views for explaining each process of fabricating the loading portions 110, 210, the vanes 300, and the frictional surfaces 120, 220, and FIG. 8 is a cross-sectional view illustrating a state in which grooved portions 500 for inserting vanes between a lower loading portion 210 and an upper loading portion 110 are formed.

Referring to FIGS. 6 and 7, a graphite adhesive is applied to each of the combined interfaces between the loading portions 110, 210, the vanes 300, and the frictional surfaces 120, 220 according to the present invention, thereby firmly fixing each element into one structure.

Furthermore, according to a preferred embodiment, an upper plate 100 (an upper loading portion 110 and an upper frictional surface 120) and a lower plate 200 (a lower loading portion 210 and a lower frictional surface 220) may be firmly fixed into one structure by respectively forming grooving portions 500 in which the vanes 300 are inserted into the lower loading portion 210 and the upper loading portion 110 by machine process in advance (refer to FIG. 8), and inserting the vanes 300 into each of the grooving portions 500.

The step S230 of performing a liquid silicon-melt infiltration process on the fabricated one structure, constituting the present invention, is a process in which the shape of each element for the disk rotor is produced using a carbon-carbon composite in the step S210, and liquid silicon is infiltrated into the pores of the carbon-carbon composite in the disk rotor structure in which the shape of each element is fabricated in the step S220.

Through the process (liquid silicon-melt infiltration) in the step S230, the SiC-component having a larger amount than that of each element itself in the disk rotor is synthesized on the fabricated interface.

Furthermore, through the process (liquid silicon-melt infiltration) in the step S230, a chemical reaction for forming the disk rotor in a completely integrated body is occurred on the fabricated interface between each element of the disk rotor and within each element itself, thereby producing a resultant ceramic brake disk rotor.

According to a preferred embodiment, such a liquid silicon-melt infiltration process(step S230) may be reiteratively performed more than once according to the characteristic of the disk rotor.

### Second Embodiment

The method of manufacturing a ceramic brake disk rotor having internal cooling channels according to a second embodiment of the present invention is similar to the configuration of the first embodiment, except that the loading portions 110, 210 of the first embodiment have a function of the frictional surfaces 120, 220 while the frictional surfaces 120, 220 are omitted. Furthermore, in the second embodiment of the invention, the same reference numerals are assigned to the same elements as those in the first embodiment, and their explanation will be omitted.

FIG. 9 is a flowchart for explaining a method of manufacturing a ceramic brake disk rotor having internal cooling channels according to a second embodiment of the present invention.

Referring to FIG. 9, a method of manufacturing a ceramic brake disk rotor having internal cooling channels, according to a second embodiment of the present invention, includes a step S610 of producing an upper loading portion 110, a lower loading portion 210, and vanes 300 respectively through separate processes using a carbon fiber reinforced carbon-carbon composite, a step S620 of fabricating the upper loading portion 110, the lower loading portion 210, and the vanes 300 respectively produced through separate processes into one structure, and a step S630 of performing a liquid silicon-melt infiltration process on the fabricated structure.

The step S610 of producing an upper loading portion 110, a lower loading portion 210, and vanes 300 of the disk rotor respectively through separate processes using a carbon fiber reinforced carbon-carbon composite constituting the second embodiment of the present invention is a process of preparing a carbon-carbon composite having an outstanding thermal resistance, high-temperature strength, and high-temperature dimensional stability, and then forming the upper/lower loading portions 110, 210 and vanes 300 into a predetermined shape that is applied to the disk rotor by machine process.

According to a preferred embodiment, the carbon-carbon composite in the step S610 may be formed by a process including a step S610-1 of producing a carbon fiber-reinforced polymer (CFRP) that is reinforced by carbon fiber; and a step of S610-2 of producing a carbon-carbon composite by performing a high thermal treatment or densification on the carbon fiber-reinforced polymer.

Furthermore, according to a preferred embodiment, a process of forming the upper/lower loading portions 110, 210 and vanes 300 into a predetermined shape that is applied to the disk rotor by machine process may be performed in the step S610-2 (the step of producing a carbon-carbon composite). In this embodiment, in the step of producing a carbon-carbon composite (step S610-2) an upper plate 100 (i.e., an upper loading portion 110) and a lower plate 200 (i.e., a lower loading portion 210) are machine processed into a planar circular disk shape, and a portion of the vanes 300 is also machine processed into a predetermined shape using a carbon-carbon composite similar to the upper plate 100 and lower plate 200. The upper plate 100 and lower plate 200 having a planar circular disk shape have a simple shape, and therefore can be processed in a relatively easy way even though strict processing tolerances are applied. Furthermore, the vanes 300 may be also produced into various shapes according to the characteristic of the required brake using cutting processing devices such as a water-jet. For example, as illustrated in FIG. 5, the vanes 300 could be produced into various shapes, such as a spiral shape 600, a linear shape 700, and a cylindrical pin shape 800 according to the characteristic of the required brake.

According to this embodiment, the upper/lower loading portions 110, 210 and the vanes 300 may be formed by a carbon-carbon composite having a same composition ratio.

According to this embodiment, carbon fiber having a length greater than 1 mm may be applied to the loading portions 110, 210 and the vanes 300 as a reinforced material. In this case, it is processed such that the density of the carbon-carbon composite for the upper/lower loading portions 110, 210 and the vanes 300 has a value of 1.0-1.7 g/cm³ (before the liquid silicon-melt infiltration process), and the upper/lower loading portions 110, 210 and the vanes 300 after a step S630 of performing the liquid silicon-melt infiltration process on a fabricated disk rotor structure, which will be described later, are synthesized with a composition ratio containing 30-70 wt % of C-component, 2-15 wt % of Si-component, and 35-65 wt % of SiC-component.

According to this embodiment, In the step S610 of producing upper/lower loading portions 110, 210 and vanes 300 of the disk rotor respectively through separate processes using a carbon fiber reinforced carbon-carbon composite, a shape of the vanes 300 is separately produced, and therefore internal cooling channels 400 may be formed without any restriction on their shape. In other words, the shape of the vanes 300 for a ceramic brake disk rotor is mostly required to have a shape with various and complicated internal cooling channels 400 to effectively radiate frictional heat created at the time of braking, and in this invention the internal cooling channels 400 of such a ceramic brake disk rotor may be produced into various shapes, such as a spiral shape 600, a linear shape 700, and a chaotic array 800 (Refer to FIG. 5).

According to this embodiment, the step 5620 of fabricating the upper/lower loading portions 110, 210 and vanes 300 respectively produced through separate processes into one structure is a process in which the upper/lower loading portions 110, 210 and vanes 300 are firmly fixed into one structure.

A graphite adhesive is applied to each of the combined interfaces between the upper/lower loading portions 110, 210 and the vanes 300 according to the present invention, thereby firmly fixing each element into one structure.

Furthermore, according to a preferred embodiment, an upper plate 100 (i.e., an upper loading portion 110) and a lower plate 200 (i.e., a lower loading portion 210) may be firmly fixed into one structure by respectively forming grooving portions 500 in which the vanes 300 are inserted into the lower loading portion 210 and the upper loading portion 110 by machine process in advance (refer to FIG. 8), and inserting the vanes 300 into each of the grooving portions 500.

The step S630 of performing a liquid silicon-melt infiltration process on the fabricated one structure, constituting the present invention, is a process in which the shape of each element for the disk rotor is produced using a carbon-carbon composite in the step S610, and liquid silicon is infiltrated into the pores of the carbon-carbon composite in the disk rotor structure in which the shape of each element is fabricated in the step S620.

Through the process (liquid silicon-melt infiltration) in the step S630, the SiC-component having a larger amount than within each element itself (carbon-carbon composite) in the disk rotor is synthesized on the fabricated interface.

Furthermore, through the process (liquid silicon-melt infiltration) in the step S630, a chemical reaction for forming the disk rotor in a completely integrated body is occurred on the fabricated interface between each element of the disk rotor and within each element, thereby producing a resultant ceramic brake disk rotor.

According to a preferred embodiment, such a liquid silicon-melt infiltration process(step S630) may be reiteratively performed more than once according to the characteristic of the disk rotor.

While in the foregoing, a technical idea of the present invention has been described by way of a few exemplary embodiments, it will be apparent to those skilled in the art that various modifications and variations can be made without departing from the essential characteristic of the invention. Therefore, it is understood that the embodiments of the invention are disclosed not to limit but to describe the technical idea of the present invention, and the scope of the technical idea of the present invention is not limited by those embodiments. The protected scope of the invention shall be defined by the appended claims, and all the technical ideas within the equivalent scope of the invention shall fall within the scope of the right of the invention.

1. A method of manufacturing a ceramic brake disk rotor having internal cooling channels, the method comprising:
(a) producing a first loading portion, a second loading portion, a first frictional surface, a second frictional surface, and a plurality of vanes of the disk rotor from a carbon fiber reinforced carbon-carbon composite, using separate processes;
(b) assembling the first loading portion, the second loading portion, the first frictional surface, the second frictional surface, and the plurality of vanes produced through separate processes into one brake disk rotor structure; and
(c) performing a liquid silicon-melt infiltration process on the assembled brake disk rotor structure.

2. The method of manufacturing a ceramic brake disk rotor as set forth in claim 1, wherein the carbon-carbon composite in element (a) is formed by a process, including:
(a1) producing a carbon fiber-reinforced polymer (CFRP) that is reinforced by carbon fiber; and
(a2) producing a carbon-carbon composite by performing a high thermal treatment or densification on the carbon fiber-reinforced polymer.

3. The method of manufacturing a ceramic brake disk rotor as set forth in claim 2, wherein the first loading portion, the second loading portion, the plurality of vanes, the first frictional surface and the second frictional surface are formed from a carbon-carbon composite having a same composition ratio.

4. The method of manufacturing a ceramic brake disk rotor as set forth in claim 2, wherein the first loading portion, the second loading portion, and the plurality of vanes are formed from a carbon-carbon composite having a same composition ratio, and the first frictional surface and the second frictional surface are formed from a carbon-carbon composite having a different composition ratio than the first loading portion, the second loading portion and the plurality of vanes.

5. The method of manufacturing a ceramic brake disk rotor as set forth in claim 3, further comprising applying carbon fiber having a length greater than 1 mm to the first loading portion, the second loading portion, the plurality of vanes, the first frictional surface and the second frictional surface as a reinforcing material, and
the first loading portion, the second loading portion, the plurality of vanes, and the first frictional surface and the second frictional surface after performing the liquid silicon-melt infiltration process are synthesized with a composition ratio containing 30-70 wt % of C-component, 2-15 wt % of Si-component, and 35-65 wt % of SiC-component.

6. The method of manufacturing a ceramic brake disk rotor as set forth in claim 4, further comprising applying carbon fiber having a length greater than 1 mm to a carbon-carbon composite for the first loading portion, the second loading portion, and the plurality of vanes as a reinforcing material, and applying carbon fiber having a length less than 1 mm is applied to a carbon-carbon composite for the first frictional surface and the second frictional surface as a reinforcing material,
the first frictional surface and the second frictional surface after performing the liquid silicon-melt infiltration process are synthesized with a composition ratio containing 55-99 wt % of SiC-component and 1-45 wt % of C-component, and
the first loading portion, the second loading portion, and the plurality of vanes after performing the liquid silicon-melt infiltration process are synthesized with a composition ratio containing 30-70 wt % of C-component, 2-15 wt % of Si-component, and 35-65 wt % of SiC-component.

7. The method of manufacturing a ceramic brake disk rotor as set forth in claim 1, wherein the plurality of vanes are produced in any one of a spiral shape, a linear shape, and a pin shape.

8. The method of manufacturing a ceramic brake disk rotor as set forth in claim 3, wherein the carbon-carbon composite for the first loading portions, the second loading portion, the plurality of vanes, and the first frictional surface and the second frictional surface before the liquid silicon-melt infiltration process has a density value of 1.0-1.7 g/cm³.

9. The method of manufacturing a ceramic brake disk rotor as set forth in claim 4, wherein the carbon-carbon composite for the first loading portion, the second loading portion, and the plurality of vanes before the liquid silicon-melt infiltration process has a density value of 1.0-1.7 g/cm³, and the carbon-carbon composite for the first frictional surface and the second frictional surface before the liquid silicon-melt infiltration process has a density value of 0.5-1.5 g/cm³.

10. A method of manufacturing a ceramic brake disk rotor, comprising the steps of:
(a) producing an upper loading portion, a lower loading portion, and a plurality of vanes from a carbon fiber reinforced carbon-carbon composite, using separate processes;
(b) assembling the upper loading portion, the lower loading portion, and the plurality of vanes respectively produced through separate processes into one brake disk rotor structure; and
(c) performing a liquid silicon-melt infiltration process on the assembled brake disk rotor structure.

11. The method of manufacturing a ceramic brake disk rotor as set forth in claim 10, wherein the the step the assembled brake disk rotor structure in (b) is assembled by applying a graphite adhesive between the lower loading portion and the plurality of vanes, and between the plurality of vanes and the upper loading portion.

12. The method of manufacturing a ceramic brake disk rotor as set forth in claim 10, wherein the the step the assembled brake disk rotor structure in (b) is assembled by respectively forming grooved portions in which the plurality of vanes are inserted into the lower loading portion and the upper loading portion in advance, and inserting the plurality of vanes into each of the grooved portions.

13. The method of manufacturing a ceramic brake disk rotor as set forth in claim 4, wherein an upper plate and a lower plate is fabricated by respectively applying a graphite adhesive between an upper loading portion and an upper frictional surface, and between a lower loading portion and a lower frictional surface, and then plurality of vanes are finally fabricated into the respectively fabricated upper plate and lower plate.

14. The method of manufacturing a ceramic brake disk rotor as set forth in claim 13, wherein it is finally fabricated by respectively forming grooved portions in which the plurality of vanes are inserted into the upper loading portion and the lower loading portion in advance, and inserting the plurality of vanes into each of the grooved portions.

15. The method of manufacturing a ceramic brake disk rotor as set forth in claim 1, wherein the disk rotor is fabricated as a completely integrated body by performing the liquid silicon-melt infiltration process on the assembled one brake disk rotor structure, and through a chemical reaction on the fabricated interface and within the carbon-carbon composite.

16. The method of manufacturing a ceramic brake disk rotor as set forth in claim 15, wherein a SiC-component having a larger amount than that within the carbon-carbon composite is synthesized on the fabricated interface by the liquid silicon-melt infiltration process.
